(19) United States
(12) Patent Application Publication
(10) Pub. No.: US 2002/0061733 A1
(43) Pub. Date: May 23, 2002

(54) Unfolding apparatus for foldable electronic device

(76) Inventor: Zijie Wang, Shenzhen (CN)

Correspondence Address: Wei Te (Joseph) Chung, Foxconn International, Inc., 1650 Memorex Drive, Santa Clara, CA, 95050, US

(21) Appl. No.: 09/752,507

(22) Filed: Dec. 27, 2000

(30) Foreign Application Priority Data
Nov. 21, 2000 (TW) 89220210

(51) Int. Cl. H04B 1/38

(52) U.S. Cl. 455/90; 455/575

(57) ABSTRACT

A foldable electronic device has a housing (10) and a cover (20). An unfolding apparatus for automatically unfolding the cover consists of an electromagnetic coil (40) in the housing, a magnet (30) in the cover (20), and a controller (50). When the cover is in a closed position, the magnet is parallel to and opposite the electromagnetic coil. The controller is in the housing, and controls connection of the electromagnetic coil to a power supply of the electronic device. When the electromagnetic coil is connected to the power supply, a magnetic field is created around the electromagnetic coil. The magnetic field acts on a magnetic field of the magnet, and causes the magnet to unfold the cover.

### FIELD OF THE INVENTION

The present invention relates generally to an unfolding apparatus for a foldable electronic device, and more particularly to an unfolding apparatus for automatically opening the cover of a portable electronic device such as a portable telephone or personal digital assistant.

### BACKGROUND OF THE INVENTION

An ultimate object of communication is, of course, to enable information to be instantaneously transmitted or exchanged anytime, from anywhere, and by anybody. In recent years, mobile communication has been extensively developed. A great variety of communication equipment such as mobile phones and personal digital assistants (PDAs) can now be found in the marketplace. Many varieties of such equipment have a housing and a cover. The housing and the cover are connected by a hinge. When in a closed position, the cover drapes part or all of the housing. The cover typically protects a keypad on the housing from being accidentally pressed. When the electronic device is in use, the cover can be opened.

Conventionally, there are two ways to open the cover. The first way is manual opening, as disclosed in U.S. Pat. No. 5,628,089 and 5,991,638. The cover is attached to the housing by a hinge module. The cover can be positioned at a predetermined angle with respect to the housing using a detent module. To open the cover, a user has to turn the cover with one hand. This can be unduly uncomfortable and inconvenient.

The second conventional way to open the cover is automatic opening, as disclosed in U.S. Pat. No. 5,987,122. The unfolding apparatus has a torsion spring around a hinge. When the cover is closed, the spring is stretched, and a locking mechanism keeps the cover in the closed position. When the locking mechanism is unlocked, the cover is automatically opened by the torsion spring. This equipment is more user-friendly than manually operated equipment. However, the hinge module comprises numerous elements, and the interconnections among these elements are complicated. This results in undue complications when assembling the hinge module. In addition, the torsion spring is stretched each time the cover is closed. Frequent use of the cover renders the spring prone to eventually becoming damaged due to fatigue.

### SUMMARY OF THE INVENTION

In view of the above-mentioned drawbacks of the prior art, an objective of the present invention is to provide an unfolding apparatus for a foldable electronic device having a cover that can be easily and rapidly opened by a user with a single press.

Another objective of the present invention is to provide an unfolding apparatus for a foldable electronic device having a solid, durable structure.

A further objective of the present invention is to provide an unfolding apparatus for a foldable electronic device having just a few simple elements.

To achieve the above-mentioned objects, an unfolding apparatus for automatically unfolding a cover of a foldable electronic device in accordance with the present invention includes an electromagnetic coil in the housing, a magnet in the cover, and a controller. When the cover is in a closed position, the magnet is parallel to and opposite the electromagnetic coil. The controller is in the housing, and controls connection of the electromagnetic coil to a power supply of the electronic device. When the electromagnetic coil is connected to the power supply, a magnetic field is created around the electromagnetic coil. The magnetic field of the coil acts on a magnetic field of the magnet, and causes the magnet to unfold the cover.

Opening of the cover depends on magnetic force operating between the electromagnetic coil and the magnet. No torsion spring is required for opening.

### BRIEF DESCRIPTION OF THE DRAWINGS

FIG. 1A is a front planar view of a portable telephone in accordance with a preferred embodiment of the present invention;

FIG. 1B is a side planar view of the portable telephone of FIG. 1A;

FIG. 2A is a cross-sectional view of a controller of the portable telephone of FIG. 1A in a free state;

FIG. 2B is a cross-sectional view of the controller of FIG. 2A in an active state;

FIG. 3A is a perspective view of a magnetic relationship between an electromagnetic coil and a magnet of the portable telephone of FIG. 1A;

FIG. 3B is a perspective view of an alternative magnetic relationship between the electromagnetic coil and the magnet of the portable telephone of FIG. 1A.

FIG. 4 is a side planar view of the portable telephone of FIG. 1A, showing magnetic force acting to open a cover of the telephone;

FIG. 5 is a side planar view of the portable telephone of FIG. 1A, showing three positions of the cover of the telephone during the course of rotatable release of the cover from a closed position to an open position relative to a housing of the telephone; and

FIG. 6 is a cross-sectional view of a controller of a portable telephone in accordance with an alternative embodiment of the present invention, the controller being in a free state; and

FIG. 7 is a perspective view of a conventional portable telephone.

### DETAILED DESCRIPTION OF THE INVENTION

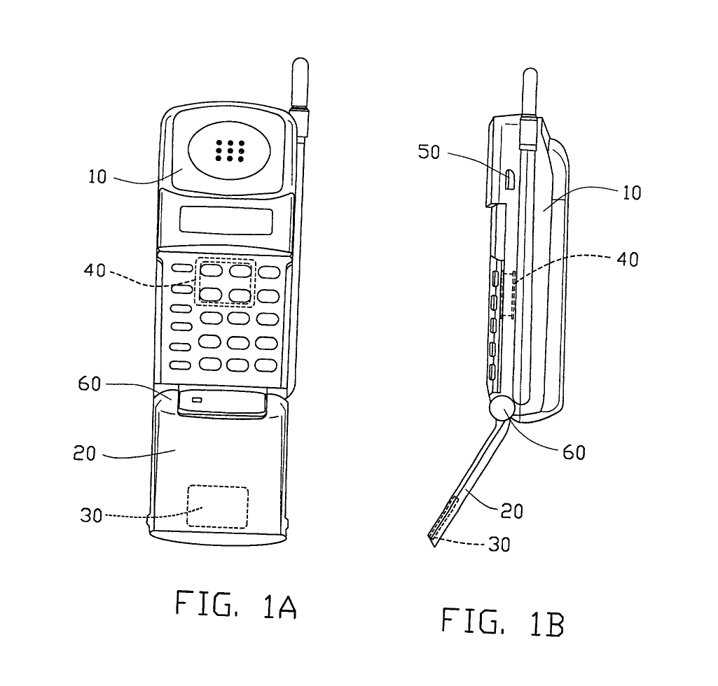

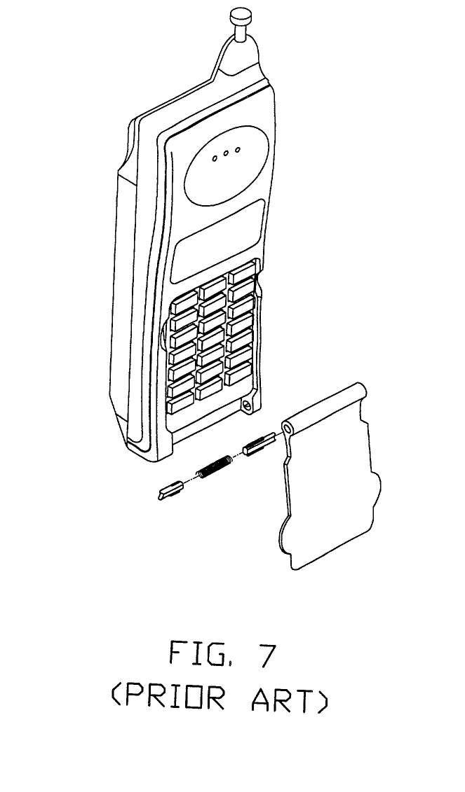

FIGS. 1A and 1B show front and side views of a portable telephone in accordance with a preferred embodiment of the present invention. A cover 20 of the telephone is rotatably connected to a housing 10 by a hinge 60. The hinge 60 is conventional, such as that illustrated in FIG. 7. The cover 20 is rotatable between a closed position and an open position relative to the housing 10. When the cover 20 is in the closed position, it covers part or all of the housing 10.

An unfolding apparatus for automatically opening the cover 20 of the telephone comprises an electromagnetic coil 40 located in the housing 10, a magnet 30 provided in the cover 20, and a controller 50. When the cover 20 is in the closed position, the magnet 30 is parallel to and opposite the electromagnetic coil 40. The controller 50 is in the housing 10, and controls connection and disconnection of an electronic circuit (not labeled) between a power source (not labeled) of the telephone and the electromagnetic coil 40. Understandably, the controller 50 may be optionally automatically activated when the telephone is changed from the off/standby status to the on/operation status. The electromagnetic coil 40 is disposed as far as possible from the hinge 60, to maximize releasing moment.

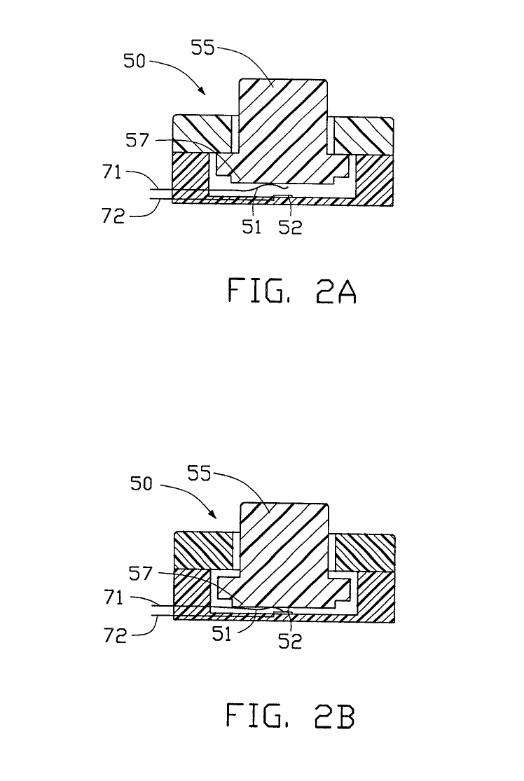

Referring to FIGS. 2A and 2B, a movable contact 51 and a stationary contact 52 of the controller 50 are connected to the circuit (not labeled) between the electromagnetic coil 40 and the power of the telephone through first and second wires 71, 72 respectively. The operator 55 of the controller 50 is pushed downwardly. A lower face 57 of the operator 55 pushes the movable contact 51 downwardly to contact the stationary contact 52. Thus the electromagnetic coil 40 is connected to the power source (not labeled) of the telephone, and a magnetic field is created around the electromagnetic coil 40.

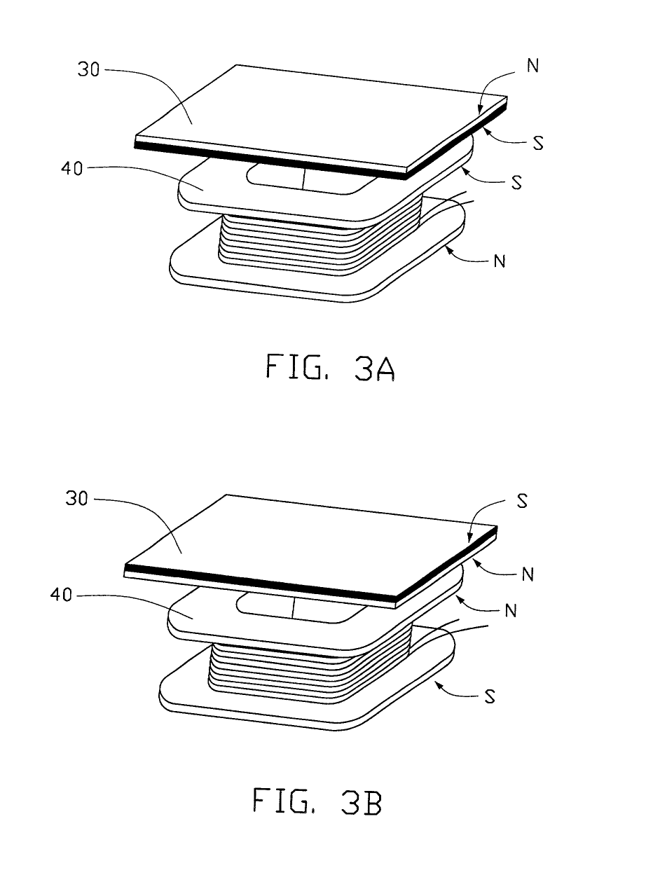

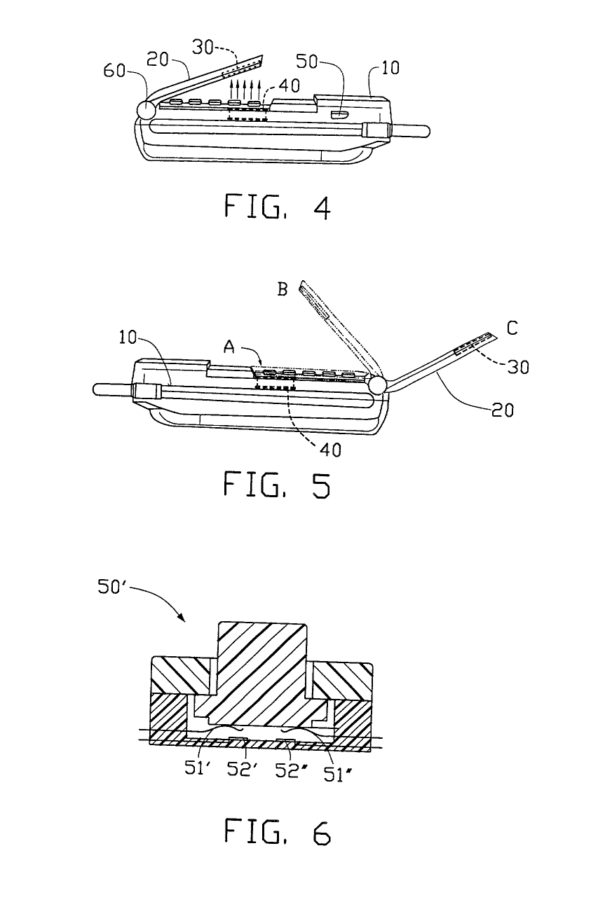

FIG. 3A shows a magnetic relationship between the electromagnetic coil 40 and the magnet 30 according to the present invention. A side of the magnet 30 nearest the electromagnetic coil 40 is the South Pole. A portion of a magnetic field generated by the electromagnetic coil 40 which is nearest the magnet 30 is also the South Pole. Thus magnetic force acting on the magnet 30 is an opening force. Such opening force is indicated by arrows in FIG. 4.

FIG. 3B shows an alternative magnetic relationship between the electromagnetic coil 40 and the magnet 30 according to the present invention. The side of the magnet 30 nearest the electromagnetic coil 40 is the North Pole. The portion of the magnetic field generated by the electromagnetic coil 40 which is nearest the magnet 30 is also the North Pole. Thus the magnetic force acting on the magnet 30 is an opening force. Such opening force is indicated by arrows in FIG. 4.

Referring to FIG. 5, items A, B and C show three positions of the cover 20 during the course of its rotatable release from the closed position to the open position relative to the housing 10. When rotating from position A to position B, the cover 20 rotates with increasing speed under the influence of the opening force. When rotating from position B to position C, the cover 20 rotates with decreasing speed because the opening moment is smaller than the resistant moment of the hinge.

FIG. 6 shows an alternative embodiment of the present invention. In the alternative embodiment, the controller 50′ has two pairs of movable and stationary contacts. A first movable contact 51′ and a first stationary contact 52′ are connected to an electronic circuit (not labeled) between the electromagnetic coil 40 and a power source (not labeled) of the telephone. A second movable contact 51Δ and a second stationary contact 52Δ function as contacts of an answering switch (not labeled) of the telephone. Thus the controller 50 has a dual function of opening the cover 20 of the telephone and allowing a user to answer an incoming message at the same time. Consequently, the user need only push the operator 55 in order to open the cover 20 and answer an incoming call or message. This is exceedingly convenient and practical for the user.

Opening of the cover 20 depends on magnetic force operating between the cover 20 and the housing 10. Thus the present invention does not require mechanical mechanisms or torsion springs to effect opening of the cover 20.

The feature of the invention is to provide the telephone with an electronic operation system for unfolding/folding the cover with regard to the housing instead of the traditional pure manual type or manual plus resilient mechanism type, thus resulting in more friendly and convenient circumstances for the user. Thus, using memory alloy induced by circuits to activate movement of the cover is also another alternatives.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. In an electronic device which has a housing and a cover movable between a closed position and an open position with respect to the housing, an unfolding apparatus for automatically opening the cover with respect to the housing, the unfolding apparatus comprising:
a first means for creating a first magnetic field, the first means being adapted to be provided in the housing of the electronic device;
a second means for creating a second magnetic field, the second means being adapted to be provided in the cover of the electronic device and be opposite to the first magnetic field when the cover is in the closed position; and
a controller for controlling at least one of the first and second means, the controller being adapted to be provided in at least one of the housing and the cover;
whereby the first and second magnetic fields interact to move the cover from the closed position to the open position.

2. The unfolding apparatus in accordance with claim 1, wherein when the cover is in the closed position, the controller enables one of the first and second means to create the corresponding first or second magnetic field, such that the created first or second magnetic field repels the second or first magnetic field of the corresponding second or first means.

3. The unfolding apparatus in accordance with claim 1, wherein the first means for creating the first magnetic field comprises an electromagnetic coil.

4. The unfolding apparatus in accordance with claim 1, wherein the second means for creating the second magnetic field comprises a magnet.

5. The unfolding apparatus in accordance with claim 1, wherein the controller comprises a movable contact and a stationary contact, and the movable contact and stationary contact are normally in an open state.

6. A portable communication device comprising:
a housing having a keypad;
a cover attached to the housing by a hinge, the cover being movable between a closed position and an open position with respect to the housing;
a first means for creating a first magnetic field, the first means being adapted to be provided in the housing;
a second means for creating a second magnetic field, the second means being adapted to be provided in the cover and be opposite to the first magnetic field when the cover is in the closed position; and
a controller having a pair of first movable and first stationary contacts respectively and a pair of second movable and second stationary contacts respectively, the pair of first contacts being connected to a power source of the device and thereby controlling at least one of the first and second means, the pair of second contacts controlling answering of incoming messages of the device, the controller being provided in at least one of the housing and the cover.

7. The portable communication device in accordance with claim 6, wherein when the cover is in the closed position, the controller enables one of the first and second means to create the corresponding first or second magnetic field such that the created first or second magnetic field repels the second or first magnetic field of the corresponding second or first means.

8. The portable communication device in accordance with claim 6, wherein the first means for creating the first magnetic field comprises an electromagnetic coil.

9. The portable communication device in accordance with claim 6, wherein the second means for creating the second magnetic field comprises a magnet.

10. The portable communication device in accordance with claim 6, wherein the first and second pairs of contacts are each normally in an open state.

11. An electronic device comprising:
a housing having a keypad;
a cover attached to the housing by a hinge;
a first means for creating a first magnetic field, the first means being adapted to be provided in the housing;
a second means for creating a second magnetic field, the second means being adapted to be provided in the coverand be opposite to the first magnetic field when the cover is in a closed position; and
a controller for creating at least one of the first and second magnetic fields to thereby control magnetic force between the first and second magnetic fields, the controller being provided in at least one of the housing and the cover.

12. The electronic device in accordance with claim 11, wherein when the cover is in the closed position, the controller enables one of the first and second means to create the corresponding first or second magnetic field such that the created first or second magnetic field repels the second or first magnetic field of the corresponding second or first means.

13. The electronic device in accordance with claim 11, wherein the first means for creating the first magnetic field comprises an electromagnetic coil, and the second means for creating the second magnetic field comprises a magnet.

14. The electronic device in accordance with claim 11, wherein the controller comprises at least one movable contact and at least one stationary contact.

15. The electronic device in accordance with claim 14, wherein each pair of contacts comprising one movable contact and one stationary contact is normally in an open state.

16. A cellular phone comprising:
a housing and a cover rotatbly attached to the housing;
a controller positioned in the housing and activated, directly or indirectly, by a button, said controller activating circuits to create inducement; and
a device mounted on the cover actuated by said inducement to rotatably move the cover relative to the housing.

17. The cellular phone in accordance with claim 16, where said device is a permanent magnet.

18. The cellular phone in accordance with claim 16, wherein said inducement is performed by an electro magnet.
